(19) United States
(12) Patent Application Publication
(10) Pub. No.: US 2013/0122400 A1
(43) Pub. Date: May 16, 2013

(54) FUEL CELL

(71) Applicants: Tae-Ho KWON, Yongin-si (KR); Sang-Jun KONG, Yongin-si (KR); Hyun SOH, Yongin-si (KR); Kwang-Jin PARK, Yongin-si (KR); Gyu-Jong BAE, Yongin-si (KR); Duy-Hyoung YOON, Yongin-si (KR); Young-Sun KWON, Yongin-si (KR)

(72) Inventors: Tae-Ho KWON, Yongin-si (KR); Sang-Jun KONG, Yongin-si (KR); Hyun SOH, Yongin-si (KR); Kwang-Jin PARK, Yongin-si (KR); Gyu-Jong BAE, Yongin-si (KR); Duy-Hyoung YOON, Yongin-si (KR); Young-Sun KWON, Yongin-si (KR)

(73) Assignee: SAMSUNG SDI CO., LTD., Yongin-si (KR)

(21) Appl. No.: 13/545,209

(22) Filed: Jul. 10, 2012

(30) Foreign Application Priority Data
Nov. 14, 2011 (KR) 10-2011-0118263

(51) Int. Cl. H01M 8/10

(52) U.S. Cl. 429/497

(57) ABSTRACT

Disclosed herein is a fuel cell including a unit cell having a electrolytic layer, a first electrode layer formed inside the electrolytic layer, and a second electrode layer formed outside the electrolytic layer. The fuel cell further includes an inner tube positioned inside the unit cell and extending in a longitudinal direction of the unit cell, the inner tube configured to fluidly connect the unit cell with another unit cell, and the inner tube having a variable outer diameter along the longitudinal direction of the unit cell. The fuel cell may be configured to improve fuel or oxidizer flow efficiency. The fuel cell may be configured to maintain flow rate for and improve rection time of fuel or oxidizer during operation of the fuel cell.

### CROSS-REFERENCE TO RELATED APPLICATIONS

This application claims priority to and the benefit of Korean Patent Application No. 10-2011-0118263, filed on Nov. 14, 2011 in the Korean Intellectual Property Office, the entire content of which is incorporated herein by reference.

### BACKGROUND

1. Field

The present disclosure relates to a fuel cell, and more particularly, to a fuel cell including an inner tube.

2. Description of the Related Technology

Solid oxide fuel cells are generally either of a tube type or a flat plate type. The tube type has a less optimum fuel cell stack power density as compared with the flat plate type. Even so, however, a power density comparison for a fuel cell system using the tube type and the flat plate type is similar. The tube type solid oxide fuel cell easily seals the unit cells forming the stack, strongly resists thermal stress, and is frequently used due to the high mechanical strength of the stack. Further research in this technology is being persued.

The tube type solid oxide fuel cell is classified into two types: first, a cathode-supported fuel cell using a cathode as a support, and second, an anode-supported fuel cell using a anode as a support. With either type of solid oxide fuel cell, gas supplied to the unit cell (for example, fuel or oxidizer, which may include air) moves in a direction parallel to a length of the unit cell. Problems, however, may occur during operation of the solid oxide fuel cell. For example, because the amount of gas in the fuel cell is proportionally small, an increase in gas flow rate across a fuel cell reaction surface may reduce reaction time.

### SUMMARY OF CERTAIN INVENTIVE ASPECTS

In one aspect, a fuel cell is provided, which is capable of flowing fuel or oxidizer inside a unit cell.

In another aspect, a fuel cell is provided, which is capable of maximizing contacting reaction time between a supplied fuel or an oxidizer and a reaction surface of the unit cell while maintaining flow rate of the fuel or the oxidizer.

In another aspect, a fuel cell is provided, which includes a unit cell and an inner tube.

In some embodiments, the unit cell may be formed as a tube type and may include a first electrode layer formed inside an electrolytic layer and a second electrode layer fromed on the outside of the electroylic layer. In some embodiments, the inner tube is formed inside the unit cell to form a flowing passage within the unit cell. In some embodiments, the unit cell is formed with a variable outer diameter along a longitudinal direction thereof. In some embodiments, the inner tube may include the supporting tube and the outer diameter portion. In some embodiments, the supporting tube is formed with a constant outer diameter. In some embodiments, the outer diameter portion is formed on the outer periphery of the supporting layer with the variable outer diameter along the longitudinal direction of the unit cell. In some embodiments, the outer diameter portion may be formed of insulating material. In some embodiments, the outer diameter portion may be formed of ceramic material. In some embodiments, the outer diameter portion may be formed of a combination of a plurality of unit blocks formed on the outer periphery of the supporting tube along the longitudinal direction thereof. In some embodiments, the plurality of unit blocks are formed in a ring shape or a tube shape, and the outer diameters of the unit blocks adjacent to each other may be different. In some embodiments, the unit blocks may have alternating small and large outer diameters along the longitudinal direction thereof. In some embodiments, the outer diameter of the unit block is formed to gradually increase from one end to the other end thereof. In some embodiments, the outer peripheries of the unit blocks are provided with a plurality of protrusions. In some embodiments, the heights of the unit blocks are uniformly formed. In some embodiments, the supporting tube may be formed of 300 base stainless steel. In some embodiments, a conductive felt layer may be provided at an inner periphery of the first electrode.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1A is a cross-section view schematically showing a shape of a unit cell.

FIG. 1B is a cross-section view schematically showing a shape of the unit cell of FIG. 1A.

FIG. 2 is a longitudinal cross-section view schematically showing the shape of the unit cell.

FIG. 3 is a prospective view showing the shape of the unit block according to an embodiment of the present disclosure.

FIG. 4 is a cut away prospective view showing the shape of the unit cell provided with an inner tube according to another embodiment of the present disclosure.

FIG. 5 is a cut away prospective view showing the shape of the unit cell provided with the inner tube according to another embodiment of the present disclosure.

FIG. 6 is a prospective view showing the shape of the unit block according to an embodiment of the present disclosure.

FIG. 7 is a cut away prospective view showing the shape of the unit cell provided with the inner tube according to another embodiment of the present disclosure.

FIG. 8 is a cut away prospective view showing the shape of the unit cell provided with the inner tube according to another embodiment of the present disclosure.

FIG. 9 is a cut away prospective view showing the shape of the unit cell provided with the inner tube according to another embodiment of the present disclosure.

### DETAILED DESCRIPTION OF CERTAIN INVENTIVE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, embodiments of the disclosure will be described with reference to the attached drawings. Without particular definition provided, terms that indicate directions used to describe the disclosure are based on the state shown in the drawings. Further, the same reference numerals indicate the same members in the embodiments. On the other hand, a thickness or a size of each component displayed on the drawings may be exaggerated for the convenience of the description, which does not mean that it should be estimated by the ratio between its size and the component.

Hereinafter, a tubular unit cell refers to the unit cell of a hollow pipe type without regard to the shape of the cross section. That is, in the tubular unit cell, the shape of the end in the vertical direction to the central axis thereof may be variously formed by circle, oval, polygon and the like.

General fuel cells include a fuel converter (a reformer and a reactor) configured for reforming and supplying the fuel, and fuel cell modules. Here, the fuel cell modules may include a fuel cell stack configured for converting chemical energy into electrical energy and thermal energy by electro-chemical methods. That is, the fuel cell modules may include a fuel cell stack, a pipe system, an interconnection and the like. The stack, which is an assembly of the unit cell, refers to a portion configured for converting chemical energy into electrical energy and thermal energy. The pipe system refers to a facility configured for moving fuel, oxide, cooling water, discharge and the like. The interconnection refers to an electrical wire configured for transferring electricity produced by the stack. In addition, the fuel cell module may include a portion configured for monitoring and/or controlling the stack, and a portion configured for performing corrective measures when the stack is abnormal. The present disclosure relates to the unit cell portion forming the stack and the module of the fuel cell formed of the stack. Hereinafter, each of components will be described in detail.

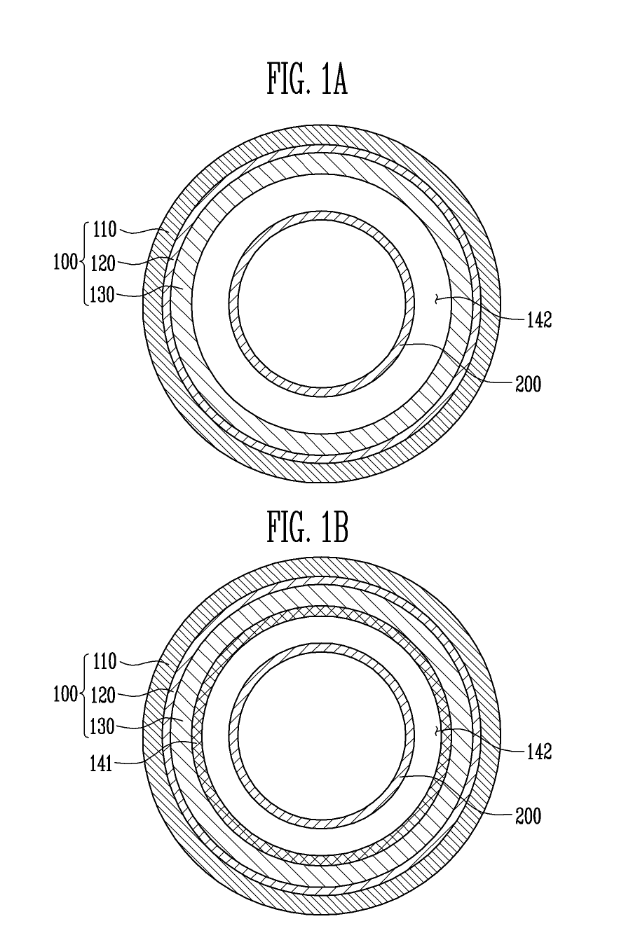

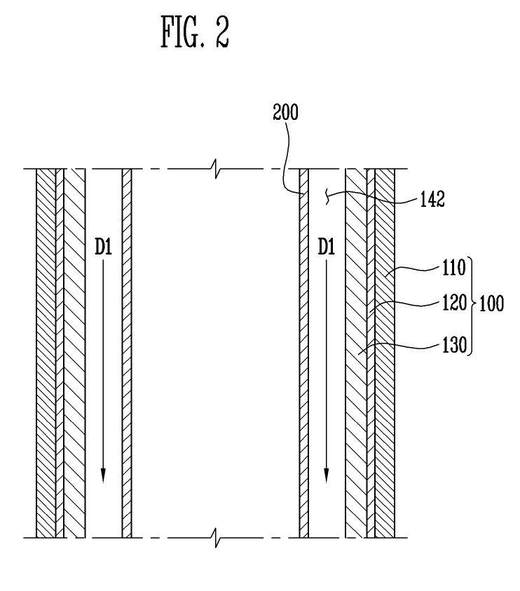

The unit cell 100 will be described with reference to FIGS. 1 and 2. FIGS. 1A and 1B are cross-section views schematically showing a shape of unit cell, and FIG. 2 is a longitudinal cross-section view schematically showing the shape of the unit cell. The unit cell 100 is configured to receive the fuel reformed from the fuel converter (not shown) to produce electricity by oxidation. The unit cell 100 is formed in a tube shape as shown in FIGS. 1 and 2. The tubular fuel cell is laminated with an anode 130, an electrolytic layer 120 and a cathode 110 described radially from a center axis thereof. The unit cell 100 is formed either as an anode-supported type or a cathode-supported type on its purpose. The present embodiment illustrates the anode-supported type with the anode 130 on the inside thereof. However, this is for ease of description and experiment, and the disclosure is not limited to the anode-supported type. Further, as mentioned above, the unit cell 100 of the disclosure is not limited to a cylindrical shape illustrated in FIGS. 1A and 1B, but may be formed in other suitable shapes as well.

The cathode may be formed with a material having high ion conductance and/or electronic conductance, such as LaMnO₃-base or LaCoO₃-base. The cathode may be manufactured with a pure electronic conductor or a mixed conductor that is stable in oxidizing atmosphere and/or that would not chemically react with the electrolytic layer. The electrolytic layer is configured to be the moving passage for oxygen ion produced from the cathode and hydrogen ion produced from the anode. Such an electrolytic layer may be formed of compact ceramic material. The ceramic material may be so compact that the gas cannot penetrate. The anode may be formed of the ceramic material such as YSZ (yttria-stabilized zirconia) similar to that described above. In some embodiments it is preferable to use metal ceramic cermet such as NiO—8YSZ or Ni—8YSZ that is inexpensive and stable in a high-temperature reducing atmosphere.

For efficient current collection, a felt layer 141 may be provided at an inner periphery of the anode 130. In this case, the felt layer 141 may be formed of a porous or conductive member, which is configured to pass the fuel and function as a collector, to thereby improve collecting efficiency. The felt layer 141 may be formed to include a metal to further improve the collecting efficiency. In some embodiments, the metal may include nickel (Ni). The felt layer 141 may include other components having similar current collecting function.

On the other hand, the inside of the unit cell includes the inner tube 200. The inner tube 200 may be formed of stainless steel or the like and be configured both to support the entire structure of the unit cell 100 and to form a flowing passage 142 for the reformed fuel (however, in the case of the cathode-supported unit cell, the flowing passage may be configured to move an oxidation agent such as air). During operation, the reformed fuel moves in an approximately straight line without changing the moving passage. However, since the reformed fuel moves in the D1 direction parallel to the unit cell 100 along the inner periphery of the anode 130 for the inside of the unit cell 100, the proportional amount of gas participating in reaction is small. Flow rate of reformed fuel may be increased to attempt to increase electricity production of the fuel cell. However, as the flow rate increases, reaction time between the reformed fuel and the anode 130 becomes shorter. Thus, some embodiments of the present disclosure address this problem.

### Embodiment 1

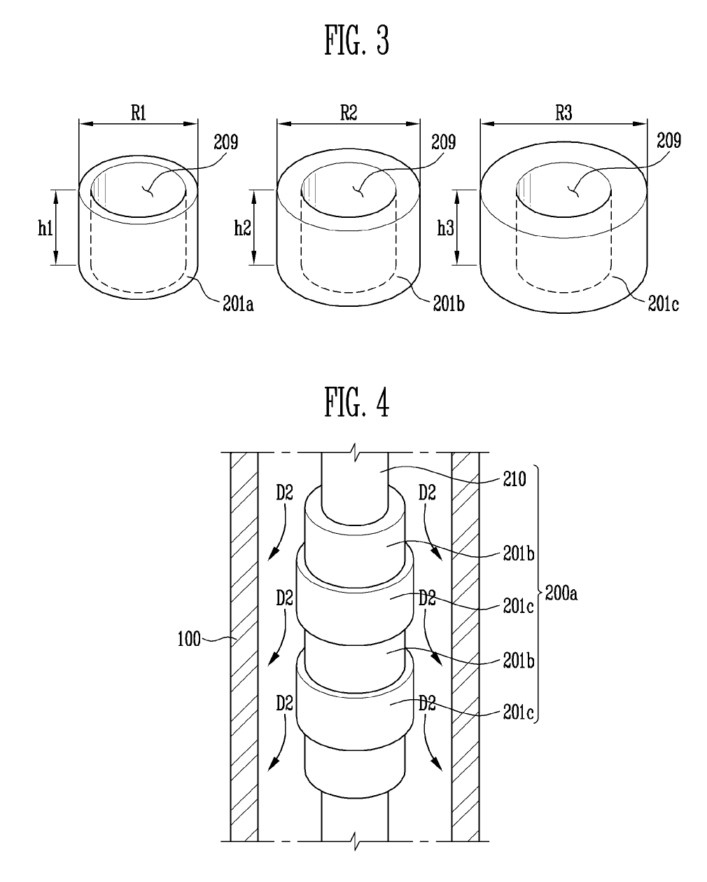

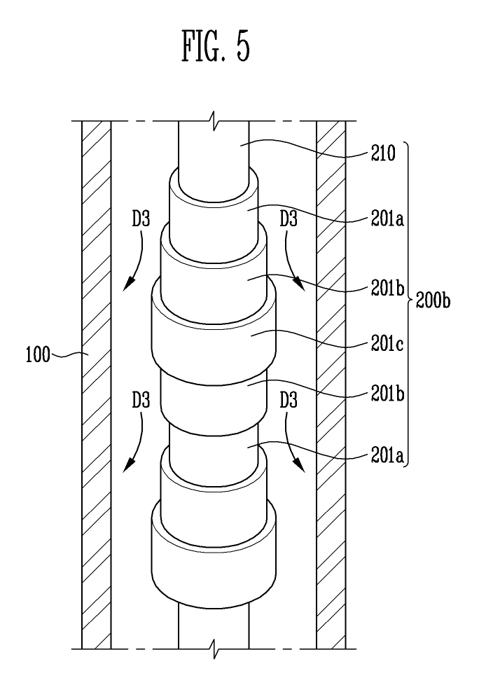

The unit cell including the inner tube of an embodiment will be described with reference to FIGS. 3 to 5. FIG. 3 is a prospective view showing the shape of the unit block according to an embodiment of the present disclosure. FIG. 4 is a cut away prospective view showing the shape of the unit cell provided with the inner tube according to another embodiment of the present disclosure. FIG. 5 is a cut away prospective view showing the shape of the unit cell provided with the inner tube according to another embodiment of the present disclosure.

In the Embodiment 1, the outer diameter of the inner tube is varied along the longitudinal direction of the unit cell by using the unit blocks having varying outer diameters. For example, in FIG. 4 the inner tube 200a is formed to have an irregular outer diameter along the longitudinal direction of the unit cell 100. First, the outside of a supporting tube 210 is provided with the inner tube 200a combining the unit block 201a, 201b, 201c shown in FIG. 3. It is preferable to form each of the unit blocks 201a, 201b, 201c with an insulating material, particularly the ceramic material. Further, the unit blocks 201a, 201b, 201c are formed having a ring shape or a tube shape. Each of the inner diameter 209 of the unit blocks 201a, 201b, 201c is the same. On the other hand, at least two of the unit blocks 201a, 201b, 201c have an outer diameter different from each other. The outer diameters from the smallest to the biggest in the Embodiment 1 include a first unit block 201a having the smallest outer diameter R1, a second unit block 201b having the outer diameter of a medium size, and a third unit block 201c having the biggest outer diameter R3. On the other hand, It is preferable to form heights h1, h2, h3 of each of the unit blocks 201a, 201b, 201c equally to obtain a regular reaction ratio along the longitudinal direction of the unit cell 100 by flowing uniform reformed gas.

The inner tube 200a that includes the second unit block 201b and the third unit block 201c may be formed as illustrated in FIG. 4. The supporting tube 210 is provided along the longitudinal direction inside the unit cell 100. The second unit block 201b and the third unit block 201c are alternately inserted outside the supporting tube 210. The flowing passage is formed between the outer diameter portion 201b, 201c and the inner periphery of the unit cell 100 to move the reformed fuel during operation of the fuel cell. The reformed fuel flows in the D2 direction due to irregular diameter of the outer diameter 201b, 201c. Thus, a mixing action of the reformed fuel is generated during fuel flow as compared with the straight line flowing passage D1 described previously with regard to FIG. 2. Further, reaction time for fuel contacting the anode of the inner periphery of the unit cell 100 is increased as compared with that of the embodiment of FIG. 2. Further in contrast to the embodiment of the unit cell 100 where fuel may only flow in one direction D1, the reformed fuel in Embodiment 1, may be configured to flow either from the top to the bottom (in the direction D2) or from the bottom to the top.

FIG. 5 shows the inner tube 200b combining the first unit block 201a, the second unit block 201b, and the third unit block 201c. That is, a change of the outer diameter of the inner tube 200b is formed by inserting the first unit block 201a, the second unit block 201b, and the third unit block 201c into the supporting tube 210, and again inserting the second unit block 201b and the first unit block 201a. Even in this case, a flowing passage is formed between the outer diameter portion 201a, 201b, 201c and the inner periphery of the unit cell 100, and thus, during operation of the fuel cell the reformed material flows in a direction D3.

In some embodiments, the unit blocks may be inserted outside the supporting tube 210 in any order. In some embodiments, the reformed material has irregular flows when the unit blocks are inserted so as to vary the outer diameter. Thus, the reaction of fuel contacting the anode may occur along the longitudinal direction the unit cell.

The outer diameter of the supporting tube 210 may be formed such that the supporting tube 210 may be inserted inside the unit blocks 201a, 201b, 201c. The outer diameter of the supporting tube 210 may be formed to have smaller outer diameter than the inner tube 200 shown in FIGS. 1 and 2. The outer diameter of the supporting tube 210 may be formed of the same material as the inner tube 200 shown in FIGS. 1 and 2. That is, the supporting tube 210 may be formed of a heat-resistant metal such as 300 base stainless steel or the like.

In some embodiments, unit blocks may be formed for insertion outside the supporting tube 210 as an integral member. In some embodiments, unit blocks may be formed separately and then assembled individually on the supporting tube. Separate unit blocks may be preferable for manufacturing convenience and ease of assembly.

### Embodiment 2

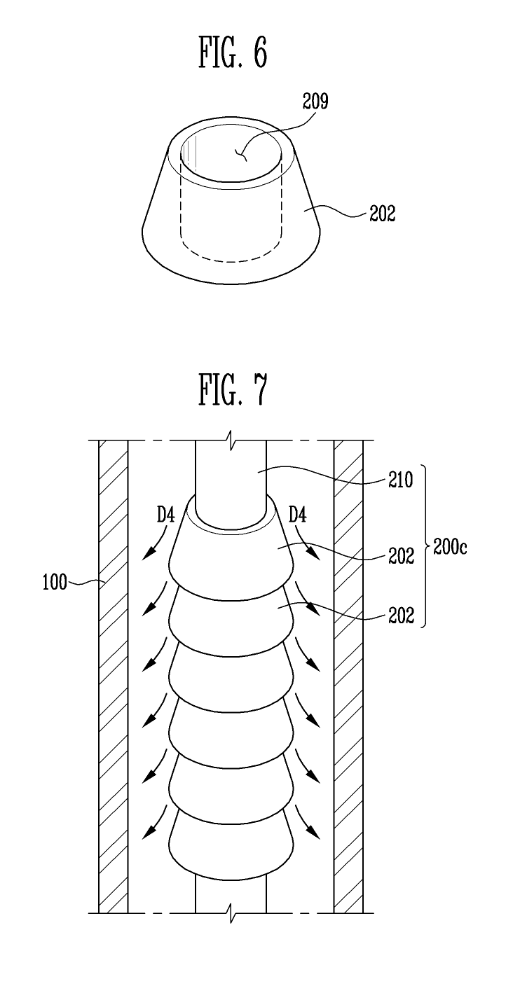

The unit cell including the inner tube of another embodiment will be described with reference to FIGS. 6 to 7. FIG. 6 is a prospective view showing the shape of the unit block according to an embodiment of the present disclosure, and FIG. 7 is a cut away prospective view showing the shape of the unit cell provided with the inner tube according to another embodiment of the present disclosure.

In the Embodiment 2, the outer diameter of the unit block itself varies. As shown in FIG. 6, the unit block 202 of the embodiment 2 is formed in the ring shape or the tube shape penetrated with the inside thereof. The inner diameter 209 of the unit block 202 is formed to be inserted outside the supporting tube 210 with small gap. On the other hand, the outer diameter of the unit block 210 is formed to gradually increase from one end to the other end thereof. The inner tube 200c is formed by inserting the unit block 202 outside the supporting tube 210.

Like the Embodiment 1, the inner tube 200c is inserted inside the unit cell 100, and a flowing passage is formed between the outer periphery of the inner tube 200c and the inner periphery of the unit cell 100. The reformed fuel moves along the flowing passage, and flows in a direction D3 due to the influence of the outer periphery of the inner tube 200c. The unit blocks 202 of the embodiment 2 may be formed to have various sizes like those in the Embodiment 1, such that the inner tube 200c may be formed in turn by inserting the unit blocks into the supporting tube 210.

### Embodiment 3

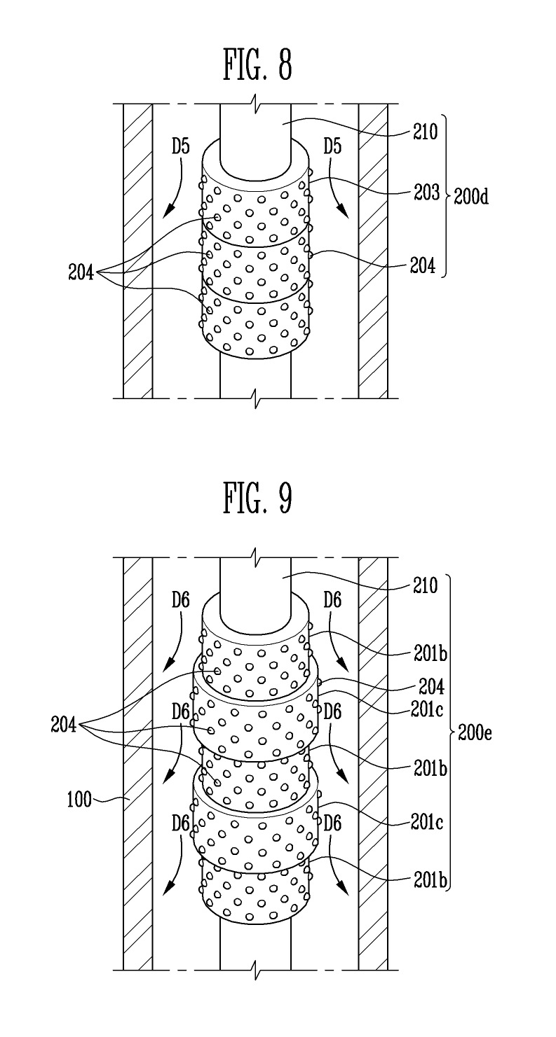

The unit cell including the inner tube of another embodiment will be described with reference to FIGS. 8 to 9. FIG. 8 is a cut away prospective view showing the shape of the unit cell provided with the inner tube according to another embodiment of the present disclosure. FIG. 9 is a cut away prospective view showing the shape of the unit cell provided with the inner tube according to another embodiment of the present disclosure. In the Embodiment 3, the inner tube formed with protrusions will be described. Each of the embodiments described in the present disclosure may include protrusions similar to those described with reference to Embodiment 3.

As shown in FIG. 8, the outer periphery of the unit block 203 is provided with a plurality of protrusions 204. Even in the case that the outer diameter of the unit block 203 to be inserted to the outside of the supporting tube 210 is not varied along the longitudinal direction of the unit cell 100, the protrusions 204 formed in the outer diameter of the unit blocks 203 are configured to prevent the reformed material from moving in a straight line in order to form a flow of reformed gas D5.

On the other hand, even in the case that the outer diameter of the unit blocks 203 is constant and the outer diameters of the unit blocks 201b, 201c are varied along the longitudinal direction of the unit cell 100 as shown in FIG. 9, the reformed fuel actively flows in a direction D6 by forming the protrusions 204 on the outer periphery thereof

Embodiments of the present disclosure may be configured to affect flow of fuel or oxidizer inside the unit cell by irregularly forming or regularly increasing and decreasing an outer diameter of the inner tube formed inside the unit cell.

Finally, embodiments of the fuel cell of the prevent disclosure may be configured to improve the efficiency of the fuel cell with an assembly configured to flow fuel or oxidizer inside the unit cell to maximize reacting time between the fuel or the oxidizer and reacting surface of the inside of the unit cell while maintaining flow rate of the fuel or the oxidizer.

While the present disclosure has been described in connection with certain exemplary embodiments, it will be appreciated by those skilled in the art that various modifications and changes may be made without departing from the scope of the present disclosure. The drawings and the detailed description of certain inventive embodiments given so far are only illustrative, and they are only used to describe certain inventive embodiments, but are should not used be considered to limit the meaning or restrict the range of the present disclosure described in the claims. Indeed, it will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Therefore, it will be appreciated to those skilled in the art that various modifications may be made and other equivalent embodiments are available. Accordingly, the actual scope of the present disclosure must be determined by the spirit of the appended claims, and-equivalents thereof

What is claimed is:

1. A fuel cell, comprising:
a unit cell including a electrolytic layer, a first electrode layer formed inside the electrolytic layer, and a second electrode layer formed outside the electrolytic layer; and
an inner tube positioned inside the unit cell and extending in a longitudinal direction of the unit cell, the inner tube configured to fluidly connect the unit cell with another unit cell, and the inner tube having a variable outer diameter along the longitudinal direction of the unit cell.

2. The fuel cell of claim 1, wherein the inner tube includes
a supporting tube having constant outer diameter; and
an outer diameter portion formed on the outer diameter of the supporting tube, the outer diameter portion having the variable outer diameter along the longitudinal direction of the unit cell.

3. The fuel cell of claim 2, wherein the outer diameter portion is formed of an insulating material.

4. The fuel cell of claim 3, wherein the outer diameter portion is formed of a plurality of unit blocks along the longitudinal direction of the unit cell.

5. The fuel cell of claim 4, wherein each of the plurality of unit blocks is formed in a ring-shape or a tube-shape, and outer diameters of each of the plurality of unit blocks formed adjacent to each other is different.

6. The fuel cell of claim 5, wherein each of the plurality of unit blocks has an increaseing outer diameter along the longitudinal direction of the unit cell.

7. The fuel cell of claim 5, wherein each of the plurality of unit blocks has a decreasing outer diameter along the longitudinal direction of the unit cell.

8. The fuel cell of claim 4, wherein each of the plurality of unit blocks has a different outer diameter at each end thereof

9. The fuel cell of claim 4, wherein the outer diameter of each of the unit blocks includes a plurality of protrusions.

10. The fuel cell of claim 4, wherein the heights of each of the plurality of unit blocks is constant.

11. The fuel cell of claim 1, wherein the inner periphery of the first electrode layer is formed of a conductive felt layer.

12. The fuel cell of claim 1, wherein the unit cell is formed having a tubular shape.
